(19) United States
(12) Patent Application Publication
(10) Pub. No.: US 2006/0112747 A1
(43) Pub. Date: Jun. 1, 2006

(54) Energy storing electronic lock

(75) Inventors: Charles W. Moon, Colorado Springs, CO (US); Willy Ruythooren, Sint-Niklaas (BE); Michael J. Wright, Santa Ana, CA (US)

Correspondence Address: CARLSON, GASKEY & OLDS, P.C., 400 WEST MAPLE ROAD, SUITE 350, BIRMINGHAM, MI, 48009, US

(73) Assignee: Computerized Security Systems, Inc.

(21) Appl. No.: 11/001,288

(22) Filed: Dec. 1, 2004

(51) Int. Cl. E05B 47/06

(52) U.S. Cl. 70/283

(57) ABSTRACT

An electronic lock includes a compression spring that stores energy to ensure that the electronic lock re-locked after unlocking. The spring is received between a lock bolt and a lock bolt housing. When the electronic lock is locked, the lock bolt is received in a notch of a locking portion. When the electronic lock is unlocked, a motor moves both the lock bolt and the lock bolt housing in a direction to remove the lock bolt from the notch. After a predetermined amount of time, the motor is reversed to move the lock bolt housing in an opposing direction. If the outside handle has not been released, the lock bolt does not re-enter the notch. The spring is compressed between the lock bolt housing and the lock bolt and stores energy. When the outside handle is released and the notch returns to the original position, and the spring pushes the lock bolt into the notch to ensure the electronic lock is re-locked.

### TECHNICAL FIELD

The present invention relates to an electronic lock, and more particularly to an electronic lock including a compression spring that stores energy to ensure that the electronic lock relocks after unlocking.

### BACKGROUND OF THE INVENTION

Door locks in hotels often use electronic key cards rather than normal mechanical keys to control lock operation. Electronic key cards and electronic locks are easily programmable and therefore provide added security in a convenient manner.

When a currently-known electronic lock is locked, a lock bolt is received in a notch in a rotatable portion connected to an outside handle, preventing the rotatable portion, and therefore the outside handle, from being rotated to open a door and access a room. When a person wants to enter the room, the electronic key card is inserted into a slot in the electronic lock. If a card reader in the electronic lock identifies the electronic key card, a motor removes the lock bolt from the notch in the rotatable portion, allowing the rotatable portion and the outside handle to be rotated to open the door.

After a predetermined amount of time, the motor reverses to re-insert the lock bolt into the notch of the locking portion to prevent the outside handle from being actuated. However, if the outside handle has not been released and the locking portion has not returned to the original position, the lock bolt cannot re-enter the notch of the rotatable portion. When the outside handle is finally released and the locking portion returns to the original position, it is possible that the lock bolt might not re-enter the notch in the locking portion, possibly preventing the electronic lock from relocking.

Another drawback to known electronic locks is that a different lock is required for a door needing a lock with handles having a right-hand configuration and a door needing a lock with handles having a left-hand configuration. Therefore, two different types of locks need to be manufactured.

There is therefore a need in the art for an electronic lock that ensures that the electronic lock relocks after a handle is actuated to enter a room and that can be mounted in either a left-hand configuration or right-hand configuration.

### SUMMARY OF THE INVENTION

A door includes an inside handle, an outside handle, and an electronic lock. When the electronic lock is locked, the outside handle cannot be actuated, preventing access to a room. The electronic lock includes a locking portion attached to the outside handle and a mounting portion attached to the inside handle.

The electronic lock includes a compression spring that stores energy to ensure that the electronic lock is re-locked after the electronic lock is unlocked. The compression spring is received in a lock bolt and a lock bolt housing.

When the electronic lock is locked, the lock bolt is received in a notch of the locking portion, preventing rotation of the locking portion and therefore actuation of the outdoor handle. When an electronic key card is inserted into the electronic lock and identified by a card reader, a motor moves the lock bolt and the lock bolt housing in a direction to remove the lock bolt from the notch in the locking portion. The locking portion and the outside handle can then be rotated, allowing the door to be opened to access the room.

After a predetermined amount of time, the motor is actuated in a reverse direction to move the lock bolt housing in an opposing direction. If the outside handle has not yet been released, the notch of the locking portion does not align with the lock bolt, preventing the lock bolt from re-entering the notch. The lock bolt does not move with the lock bolt housing in the opposing direction, and the compression spring is compressed between the lock bolt housing and the lock bolt to store energy.

After the outside handle is released, the locking portion returns to the original position, and the notch of the locking portion aligns with the lock bolt. The energy stored in the compression spring pushes the lock bolt to enter the notch, ensuring that the electronic lock is locked after the outside handle is released.

The electronic lock can be mounted in either a right-hand configuration or a left-hand configuration. The locking portion includes a raised arched portion, and the mounting portion includes an arched recess including a raised arched portion. The mounting portion can be rotated 180° to change the electronic lock between configurations. In either configuration, when the inside handle is rotated, the inside handle rotates the mounting portion to open the door. When the outside handle is rotated, the outside handle rotates the locking portion, and the raised arched portion of the locking portion engages the raised arched portion of the mounting portion to rotate both the locking portion and the mounting portion to open the door.

### BRIEF DESCRIPTION OF THE DRAWINGS

FIG. 1 is a perspective view of an electronic lock of the present invention attached to a door;

FIG. 2 is an exploded view of the electronic lock of the present invention;

FIG. 3 schematically illustrates a side view of the electronic lock when locked;

FIG. 4 schematically illustrates an exploded view of components of the electronic lock;

FIG. 5 schematically illustrates an exploded cross-sectional view of components of the electronic lock;

FIG. 6A schematically illustrates a side view of the electronic lock when locked;

FIG. 6B schematically illustrates a side view of the electronic lock when unlocked;

FIG. 6C schematically illustrates a side view of the electronic lock when an outside handle has been actuated;

FIG. 6D schematically illustrates a side view of the electronic lock when a motor reverses movement of the lock bolt housing;

FIG. 6E schematically illustrates a side view the electronic lock after the outside handle has been released;

FIG. 6F schematically illustrates a side view of the electronic lock after the compression spring pushes the lock bolt into a notch of the rotatable portion;

FIG. 7 schematically illustrates a cross-sectional view of the electronic lock;

FIG. 8A schematically illustrates front view of the mounting portion when the electronic lock is mounted in a left-hand configuration;

FIG. 8B schematically illustrates front view of the mounting portion when the electronic lock is mounted in a right-hand configuration;

FIG. 9A schematically illustrates a front view of components of the electronic lock when mounted in a left-hand configuration; and

FIG. 9B schematically illustrates a front view of components of the electronic lock when mounted in a right-hand configuration.

### DETAILED DESCRIPTION OF THE PREFERRED EMBODIMENTS

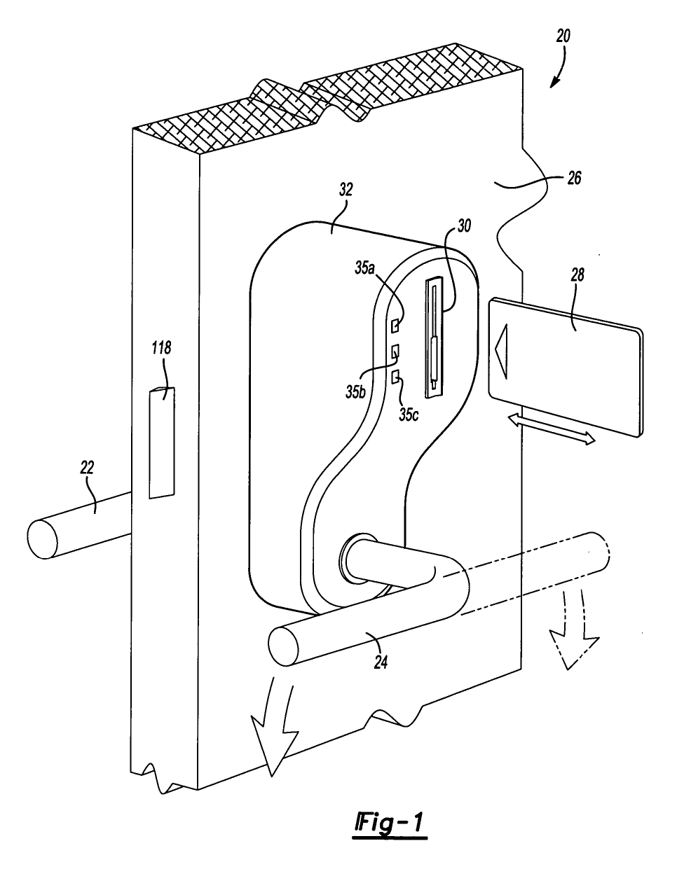

FIG. 1 schematically illustrates the electronic lock 20 of the present invention. The electronic lock 20 includes a manually-operable inside handle 22 and outside handle 24, which are both attached to the electronic lock 20 in a conventional manner. The inside handle 22 is accessible from inside a room, and the outside handle 24 is accessible from outside the room. The electronic lock 20 is attached to a door 26. When the electronic lock 20 is locked, the outside handle 24 cannot be actuated and the door 26 cannot be opened. When the electronic lock 20 is unlocked, the outside handle 24 can be actuated and the door 26 can be opened to access the room. The inside handle 22 can always be actuated.

When a person wants to enter the room, an electronic key card 28 is inserted into a slot 30 in a housing 32 of the electronic lock 20. If a card reader (not shown) positively identifies the electronic key card 28, the electronic lock 20 is unlocked, allowing the outside handle 24 to be actuated. As either the inside handle 22 or the outside handle 24 is actuated, a tab 118 in the door 26 is removed from an opening (not shown) in the door trim (not shown), allowing the door 26 to be opened.

The electronic lock 20 may include indicator lights 35a, 35b and 35c. When the electronic key card 28 is incorrectly inserted in the slot 30 or if the electronic key card 28 is not programmed to unlock the electronic lock 20, the light 35a displays red. If the electronic lock 20 malfunctions, the light 35b displays yellow. If the electronic key card 28 is identified, the light 35c displays green, and the outside handle 24 can be actuated to open the door 26 and access to the room. Of course, other illumination structures and schemes may be implemented without departing from the scope of the invention.

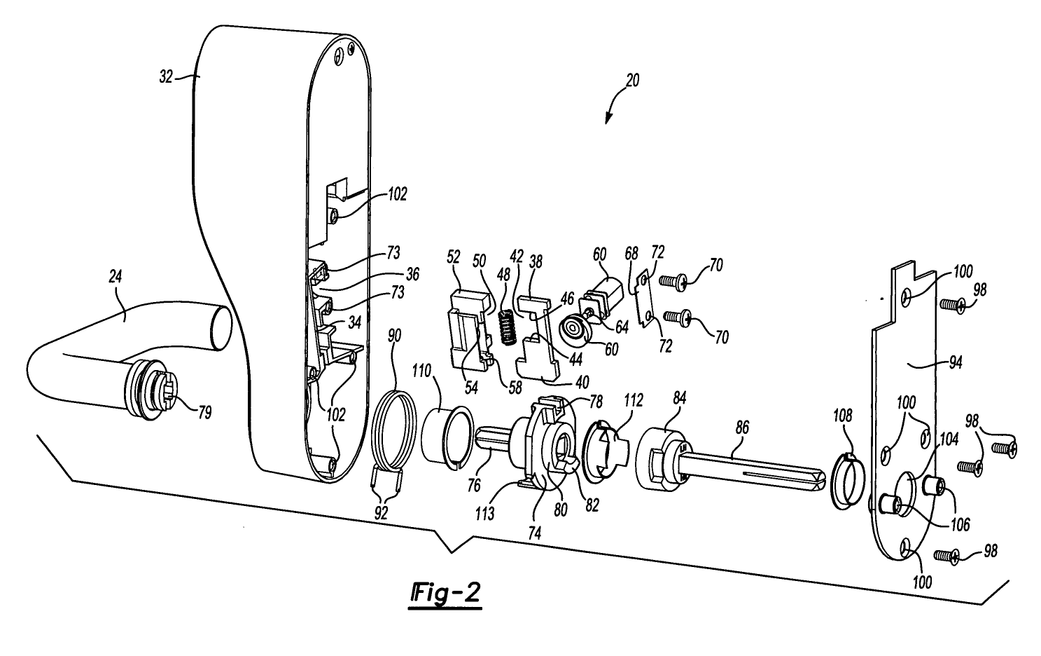

FIG. 2 schematically illustrates an exploded view of the electronic lock 20 of the present invention. The housing 32 includes an interior housing structure 34 defining an opening 36. The electronic lock 20 further includes a lock bolt 38 having a tab 40 and a recess 42 with a first edge 44 and an opposing second edge 46. A resilient member, such as a compression spring 48, is received between the edges 44 and 46 of the recess 42 of the lock bolt 38. In one example, the lock bolt 38 is made of metal. However, it is to be understood that the lock bolt 38 can be made of other materials, and one skilled in the art would know what materials to use.

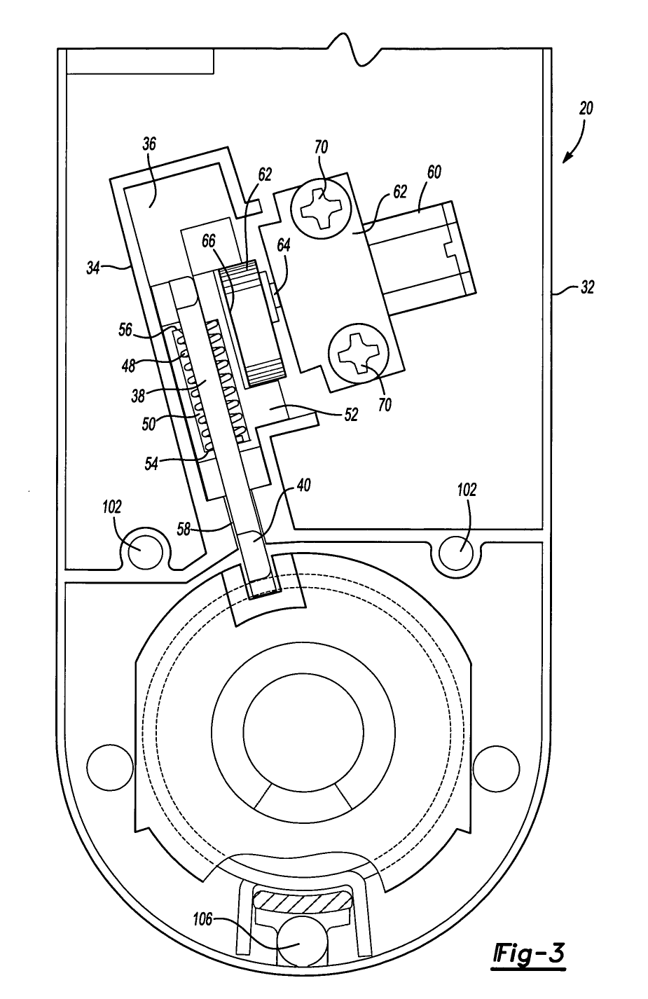

A portion of the lock bolt 38 is received in a recess 50 of a lock bolt housing 52 (further shown in FIG. 4). The recess 50 of the lock bolt housing 52 has a first edge 54 and an opposing second edge 56. When the lock bolt 38 is received in the recess 50 of the lock bolt housing 52, the compression spring 48 is also received between the first edge 54 and the opposing second edge 56 of the recess 50 in the lock bolt housing 52 (shown in FIGS. 3 and 4). The lock bolt 38 and the lock bolt housing 52 are received in the opening 36 in the interior housing structure 34 of the housing 32.

The lock bolt housing 52 also includes a slot 58 that allows the lock bolt 38 to slide relative to the lock bolt housing 52. When the lock bolt 38 slides relative to the lock bolt housing 52, the compression spring 48 is compressed between the edge 44 of the recess 42 of the lock bolt 38 and the edge 56 of the recess 50 of the lock bolt housing 52. In one example, the lock bolt housing 52 is made of plastic. However, it is to be understood that the lock bolt housing 52 can be made of other materials, and one skilled in the art would know what materials to use.

When the card reader identifies the electronic key card 28, a motor 60 powered by a battery pack (not shown) is activated to unlock the electronic lock 20. A circular cam surface 62 is attached to the motor 60 by an off-center post 64. That is, the off-center post 64 is not aligned with a central axis of the circular cam surface 62. When the motor 60 is actuated, the motor 60 turns the off-center post 64 to rotate the circular cam surface 62. The off-center post 64 is not aligned with the central axis of the circular cam surface 62, and therefore the circular cam surface 62 produces a camming effect. As shown in FIGS. 3 and 4, the circular cam surface 62 of the motor 60 is received in an opening 66 of the lock bolt housing 52. As the motor 60 rotates the off-center post 64, the circular cam surface 62 in the opening 66 of the lock bolt housing 52 linearly moves the lock bolt housing 52 between a first position and a second position.

A plate 68 retains the motor 60 in the housing 32 (further shown in FIG. 3). Fasteners 70 received in aligned holes 72 in the plate 68 and holes 73 in the housing 32 secure the plate 68 to the housing 32. Preferably, two fasteners 70 are employed to secure the plate 68 to the housing 32. In one example, the fasteners 70 are screws. However, it is to be understood that other types of fasteners can be employed to secure the plate 68 to the housing 32, and one skilled in the art would know what type of fasteners to employ.

The electronic lock 20 further includes a rotatable locking portion 74 including a stem 76. The stem 76 is received in an opening 79 in the outside handle 24, and movement of the outside handle 24 rotates the locking portion 74. The locking portion 74 includes a notch 78 on an outer circumference of the locking portion 74. The locking portion 74 also includes a circular portion 80 concentric with the stem 76 and an arched portion 82 raised from the circular portion 80. The locking portion 74 also includes a flange 113 that prevents over-rotation of the locking portion 74, as explained below.

The electronic lock 20 further includes a mounting portion 84 having a stem 86. The stem 86 of the mounting portion 84 is inserted into an opening (not shown) in the inside handle 22, and movement of the inside handle 22 rotates the mountable portion 84.

A circular spring 90 including two arms 92 is received around the locking portion 74. When the electronic lock 20 is assembled, the flange 113 is received between the two arms 92 of the circular spring 90. The two arms 92 prevent over-rotation of the locking portion 74 as the outside handle 24 is actuated.

The components of the electronic lock 20 are retained in the housing 32 by a closing plate 94. Fasteners 98 received in aligned holes 100 in the closing plate 94 and holes 102 in the housing 32 secure the closing plate 94 to the housing 32. Preferably, four fasteners 98 secure the closing plate 94 to the housing 32. In one example, the fasteners 98 are screws. However, it is to be understood that the other fasteners can be employed, and one skilled in the art would know what type of fasteners to employ. Two fasteners (not shown), such as screws, pass through the two holes 106 in the closing plate 94 to further secure the housing 32 to the door 26.

When the components are retained in the housing 32, the stem 86 of the mounting portion 84 extends through an opening 104 in the closing plate 94, and the inside handle 22 can then be attached to the stem 86 of the mounting portion 84.

When assembled, a bushing 108 is located between the opening 104 in the closing plate 94 and the mounting portion 84 to prevent wear. A bushing 110 is located between the housing 32 and the locking portion 74 to prevent wear, and a bushing 112 is located between the locking portion 74 and the mounting portion 84 to prevent wear.

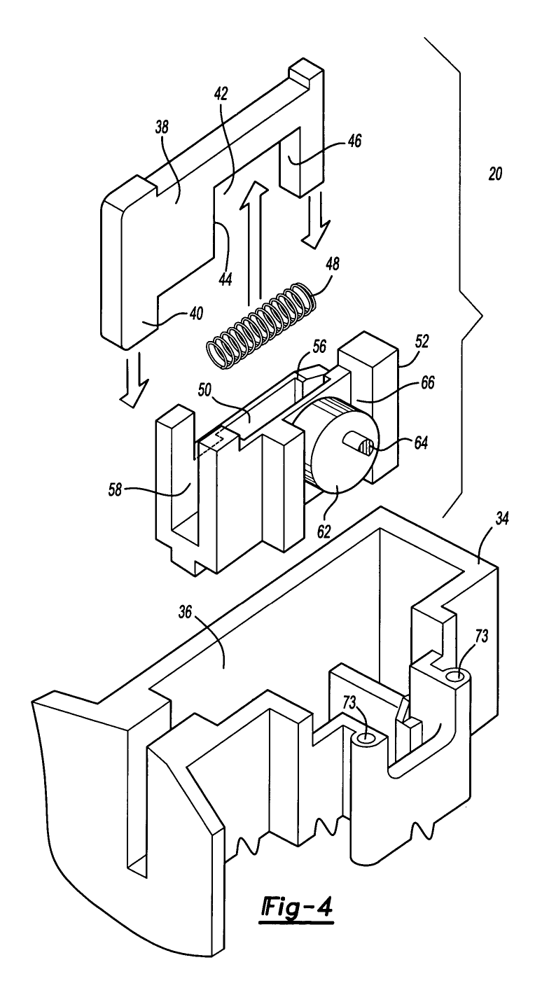

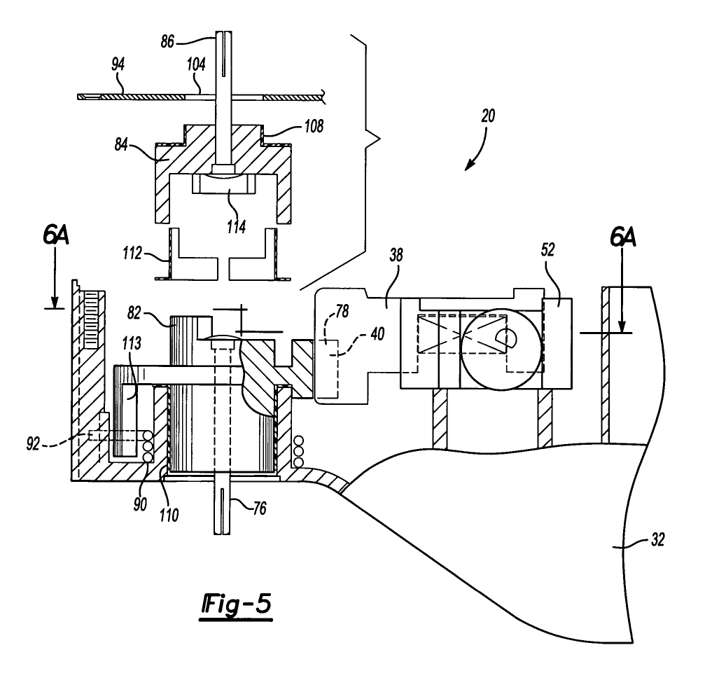

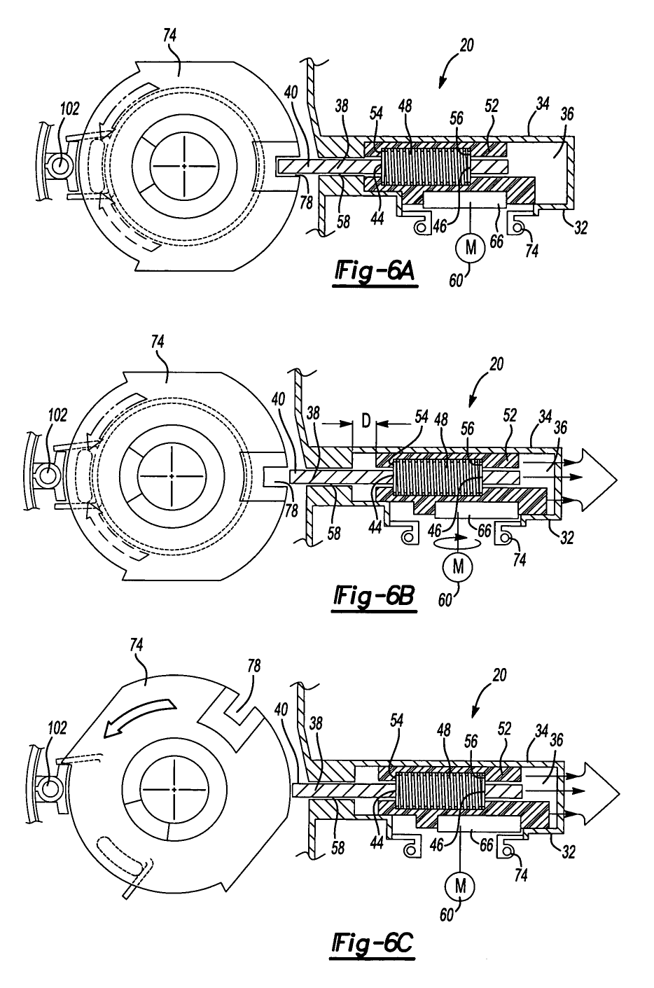

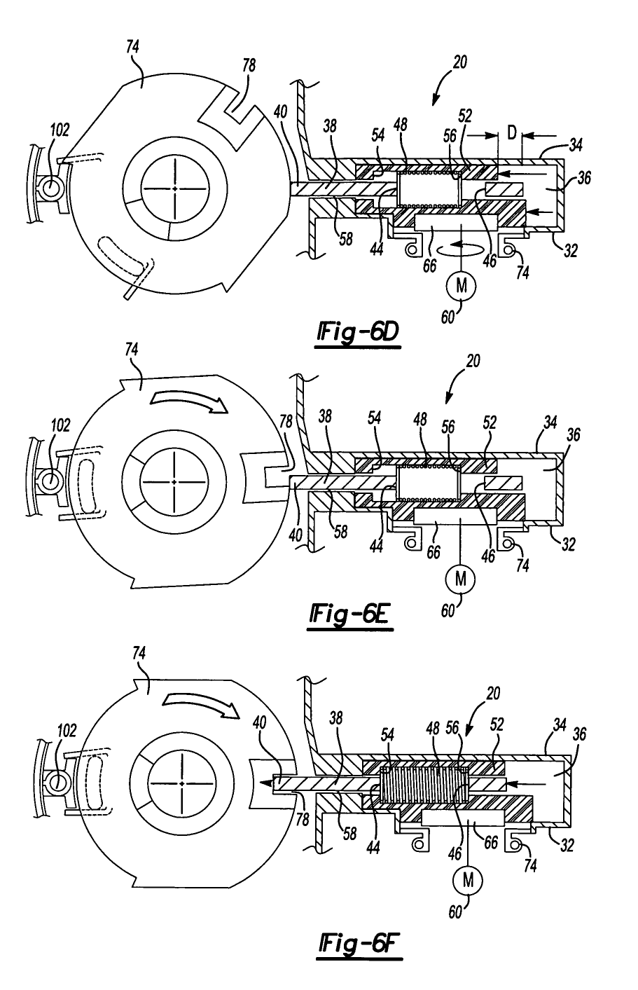

FIGS. 5 and 6A schematically illustrates the electronic lock 20 when locked. When the electronic lock 20 is locked, the outside handle 24 is in an original position. The tab 40 of the lock bolt 38 is received in the notch 78 of the locking portion 74, preventing the locking portion 74 from being rotated and preventing the outside handle 24 from being actuated to open the door 26. When an electronic key card 28 is inserted into the slot 30 and recognized by the card reader, the motor 60 rotates the off-center post 64 to rotate the circular cam surface 62. The circular cam surface 62, which is received in the opening 66, moves the lock bolt housing 52, and therefore the lock bolt 38, toward a first direction as shown in FIG. 6B to remove the tab 40 of the lock bolt 38 from the notch 78 of the locking portion 74. The tab 40 is not received in the notch 78, and the outside handle 24 can be actuated to open the door 26 and allow entry into the room. As the outside handle 24 is actuated from the original position to an actuated position, the locking portion 74 rotates to the position shown in FIG. 6C.

After a predetermined amount of time, the motor 60 is reversed to move the lock bolt housing 52 in an opposing direction as shown in FIG. 6D. If the outside handle 24 is still in the actuated position, the notch 78 is not aligned with the tab 40 of the locking portion 74. Therefore, even though the lock bolt housing 52 has moved in the opposing direction, the lock bolt 38 is maintained in the same position because the locking portion 74 prevents the lock bolt 38 from moving. The compression spring 48 compresses between the edge 56 of the lock bolt housing 52 and the edge 44 of the lock bolt 38, storing energy in the compression spring 48. Preferably, the predetermined amount of time is 5 seconds.

FIG. 6E shown the locking portion 74 as the outside handle 24 is released. As shown in FIG. 6F, when the outside handle 24 returns to the original position, the notch 78 of the locking portion 74 aligns with the tab 40 of the lock bolt 38. The energy stored in the compression spring 48 pushes the lock bolt 38 in the opposing direction, and the tab 40 of the lock bolt 38 enters the notch 78 of the locking portion 74. The compression spring 48 ensures that the tab 40 of the lock bolt 38 is received in the notch 78 of the locking portion 74. The locking portion 74 cannot be rotated, preventing the outside handle 24 from being actuated to open the door 26 and allow access to the room.

It is also possible to employ an electronic key card 28 that unlocks the electronic lock 20 and does not reverse the motor 60 until the electronic key card 28 is reinserted. In this example, the motor 60 does not reverse after the predetermined amount of time.

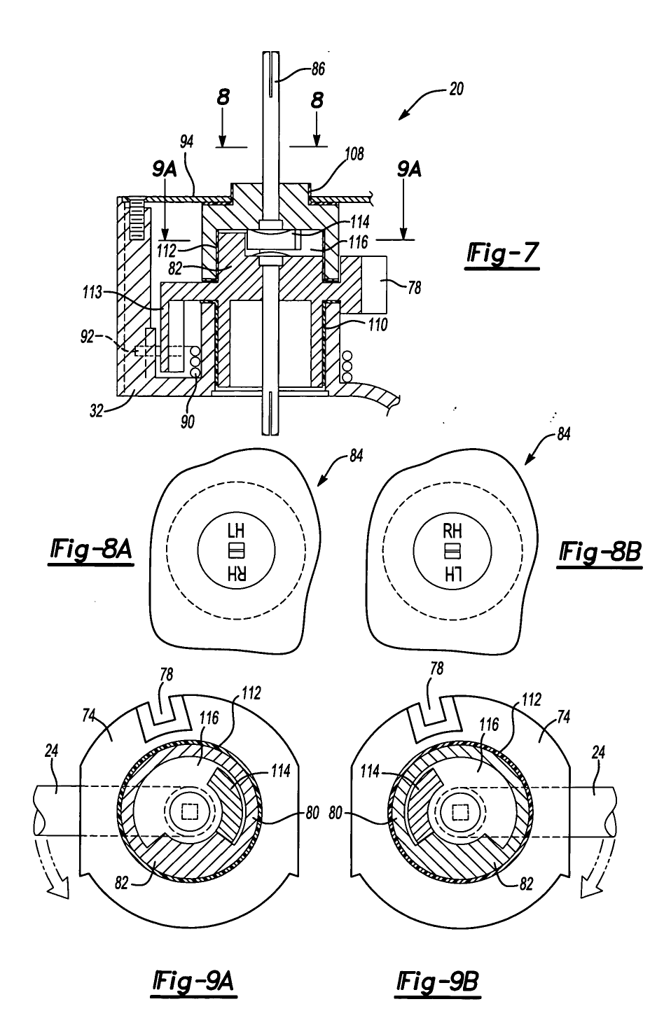

FIG. 7 schematically illustrates a cross-sectional view of the electronic lock 20 when assembled. The mounting portion 84 can be mounted to provide the electronic lock 20 with either a right-hand configuration or a left-hand configuration. When the electronic lock 20 is assembled, the arched portion 82 of the locking portion 74 is received in the arched recess 116 of the mounting portion 84.

The electronic lock 20 can be changed from the left-hand configuration to the right-hand configuration by removing and rotating the mounting portion 84 relative to the locking portion 74. As shown in FIGS. 8A and 8B, the mounting portion 84 is optionally inscribed with the letters “LH” and “RH.” When the electronic lock is installed in the left-hand configuration, the inscribed letters “LH” are located at the top of the mounting portion 84. When the electronic lock 20 is in the left-hand configuration, the outside handle 24 is mounted toward the left. To change the mounting portion 84 to the right-hand configuration, the mounting portion 84 is removed from the locking portion 74 and rotated 180° such that the inscribed letters “RH” appear at the top of the mounting portion 84. The indoor handle 22 and the outdoor handle 24 are also removed from the stems 86 and 76, respectively, and reversed 180° and reinstalled on the stems 86 and 76.

FIG. 9A illustrates the electronic lock 20 assembled in a left-hand configuration. When the mounting portion 84 is installed, the inscribed letters “LH” appear at the top of the mounting portion 84 to aid the user (FIG. 8A). When the electronic lock 20 is unlocked, the outside handle 24 can be rotated in a counter-clockwise direction to access a room. As the locking portion 74 moves with the outside handle 24, the arched portion 82 of the locking portion 74 engages the arched portion 114 of the mounting portion 84, also rotating the mounting portion 84 and the inside handle 22. The door 26 can always be opened from the inside handle 22 because actuation of the inside handle 22 moves the mounting portion 84 in a clockwise direction. When the inside handle 22 is actuated, the arched portion 82 of the locking portion 74 does not engage the arched portion 114 of the mounting portion 84, and therefore movement of the inside handle 22 does not engage the locking portion 74. Therefore, when the inside handle 22 is actuated, the outside handle 24 is not actuated and the room cannot be accessed from outside the room.

FIG. 9B illustrates the electronic lock 20 assembled in a right-hand configuration. When the mounting portion 84 is installed, the inscribed letters “RH” appear at the top of the mounting portion 84 (FIG. 8B). When the electronic lock 20 is unlocked, the outside handle 24 can be rotated in a clockwise direction to access a room. As the locking portion 74 moves with the outside handle 24, the arched portion 82 of the locking portion 74 engages the arched portion 114 of the mounting portion 84, also rotating the mounting portion 84 and the inside handle 22. The door 26 can always be opened from the inside handle 22 because actuation of the inside handle 22 moves the mounting portion 84 in a counter-clockwise direction. When the inside handle 22 is actuated, the arched portion 82 of the locking portion 74 does not engage the arched portion 114 of the mounting portion 84, and therefore movement of the inside handle 22 does not engage the locking portion 74. Therefore, when the inside handle 22 is actuated, the outside handle 24 is not actuated and the room cannot be accessed from the outside the room.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An electronic lock comprising:
a lock bolt including a lock bolt recess, wherein the lock bolt is moveable between a first lock bolt position and a second lock bolt position;
a lock bolt housing including a lock bolt housing recess, wherein the lock bolt housing is moveable between a first lock bolt housing position and a second lock bolt housing position, and lock bolt is moveable relative to the lock bolt housing; and
a resilient member received in the lock bolt recess of the lock bolt and the lock bolt housing recess of the lock bolt housing, wherein the resilient member is compressible between the lock bolt and the lock bolt housing to store energy in the resilient member.

2. The electronic lock as recited in claim 1 further comprising an actuator to move the lock bolt housing between the first lock bolt housing position and the second lock bolt housing position.

3. The electronic lock as recited in claim 2 wherein the actuator includes a motor and a circular portion attached to the motor by an off-center post, wherein the circular portion is received in a slot of the lock bolt housing, and wherein the motor rotates the off-center post to rotate the circular portion and move the lock bolt housing linearly in a first direction from the first lock bolt housing position to the second lock bolt housing position and to move the lock bolt linearly in the first direction from the first lock bolt position to the second lock bolt position.

4. The electronic lock as recited in claim 3 wherein the motor moves the lock bolt housing in a second direction opposite to the first direction after a predetermined amount of time from the second lock bolt housing position to the first lock bolt housing position.

5. The electronic lock as recited in claim 4 wherein the predetermined amount of time is approximately 5 seconds.

6. The electronic lock as recited in claim 1 further comprising:
a rotatable locking portion connectable to an outside handle moveable between an original position and an actuated position; and
a rotatable mounting portion connectable to an inside handle, wherein actuation of the outside handle rotates the rotatable locking portion and actuation of the inside handle rotates the rotatable mounting portion.

7. The electronic lock as recited in claim 6 wherein the rotatable locking portion includes a notch and the lock bolt is in the first lock bolt position and the lock bolt housing is in the first lock bolt position when the electronic lock is in a locked state, wherein the lock bolt is received in the notch of the rotatable locking portion when the electronic lock is in the locked state to prevent actuation of the outside handle.

8. The electronic lock as recited in claim 7 wherein the lock bolt is in the second lock bolt position and the lock bolt housing is in the second lock bolt position when the electronic lock is in an unlocked state, wherein the lock bolt is removed from the notch of the rotatable portion when the electronic lock is in the unlocked stated to allow rotation of the rotatable locking portion to allow actuation of the outside handle from the original position to the actuated position.

9. The electronic lock as recited in claim 8 wherein the actuator moves the lock bolt housing linearly in a first direction from the first lock bolt housing position to the second lock bolt housing position and the actuator moves the lock bolt housing in a second direction opposite to the first direction after a predetermined amount of time from the second lock bolt housing position to the first lock bolt housing position.

10. The electronic lock as recited in claim 9 wherein the lock bolt is retained in the second lock bolt position by engagement with the rotatable locking portion when the motor moves the lock bolt housing in the opposing second direction if the outside handle is in the actuated position, compressing the resilient member between the latch bolt and the latch bolt housing.

11. The electronic lock as recited in claim 10 wherein energy in the resilient member pushes the latch bolt into the notch of the rotatable portion when the outside handle returns to the original position.

12. The electronic lock as recited in claim 6 further comprising a circular resilient member having two arms, and wherein the rotatable locking portion further includes a flange, and the flange is received between the two arms of the circular resilient member to prevent over-rotation of the rotatable locking portion when rotated by the outside handle.

13. The electronic lock as recited in claim 6 further including a bushing between the rotatable locking portion and the rotatable mounting portion.

14. The electronic lock as recited in claim 1 wherein the resilient member is a compression spring.

15. The electronic lock as recited in claim 1 further including a housing having a housing recess, wherein the lock bolt and the lock bolt housing are received in a housing opening.

16. An electronic lock comprising:
a rotatable locking portion connectable to an outside handle, wherein movement of the outside handle rotates the rotatable locking portion, the rotatable locking portion including a locking arched portion; and
a rotatable mounting portion connectable to an inside handle, and movement of the inside handle rotates the rotatable mounting portion, the rotatable mounting portion includes a mounting arched portion in a recess, wherein the locking arched portion of the rotatable locking portion is moveable in the recess, and
wherein the electronic lock is convertible between a right-hand configuration where the rotatable mounting portion is in a first position and a left-hand configuration where the rotatable mounting portion is in a second position.

17. The electronic lock as recited in claim 16 wherein the first position is disposed approximately 180° from the second position.

18. The electronic lock as recited in claim 16 wherein the outdoor handle is moveable in a counter-clockwise direction when the electronic lock is in the left-hand configuration, and wherein the outdoor handle rotates the rotatable locking portion when the outdoor handle is actuated, and the locking arched portion engages the mounting locking portion to actuate the indoor handle.

19. The electronic lock as recited in claim 18 wherein the indoor handle is moveable in a clockwise direction when the electronic lock is in the left-hand configuration, wherein the indoor handle rotates the rotatable mounting portion when the indoor handle is actuated, and the rotatable mounting portion rotates relative to the rotatable locking portion.

20. The electronic lock as recited in claim 16 wherein the outdoor handle is moveable in a clockwise direction when the electronic lock is in the right-hand configuration, and the outdoor handle rotates the rotatable locking portion when the outdoor handle is actuated, and wherein the locking arched portion engages the mounting locking portion to actuate the indoor handle.

21. The electronic lock as recited in claim 20 wherein the indoor handle is moveable in a counter-clockwise direction when the electronic lock is in the right-hand configuration, and the indoor handle rotates the rotatable mounting portion when the indoor handle is actuated, and the rotatable mounting portion rotates relative to the rotatable locking portion.
